(19) United States
(12) Patent Application Publication
(10) Pub. No.: US 2006/0248224 A1
(43) Pub. Date: Nov. 2, 2006

(54) Device for navigating a vehicle and server system

(75) Inventors: Abdelkarim Belhoula, Asslar (DE); Marko Zander, Asslar (DE)

Correspondence Address: COHEN, PONTANI, LIEBERMAN & PAVANE, 551 FIFTH AVENUE, SUITE 1210, NEW YORK, NY, 10176, US

(73) Assignee: Siemens Aktiengesellschaft

(21) Appl. No.: 11/412,150

(22) Filed: Apr. 26, 2006

(30) Foreign Application Priority Data
Apr. 27, 2005 (DE) 10 2005 019 591.1

(51) Int. Cl. G06F 15/173

(52) U.S. Cl. 709/238

(57) ABSTRACT

A device designed to navigate a vehicle to a predefinable destination is configured so that the predefinable destination is predefined by a first address representation of a geographic location. The device includes at least one interface unit to which the first address representation can be supplied. The device further has an address recognition unit designed to determine a second address representation from the first address representation. The device also includes an address conversion unit designed to convert the second address representation into a geographic coordinate representation. A navigation unit is designed to carry out routing to the predefined destination as a function of the geographic coordinate representation.

### BACKGROUND OF THE INVENTION

The invention relates to a device and a server system designed to navigate a vehicle to a predefinable destination.

Devices for navigating a vehicle require, from a user of the device, separate inputting of address components which together unambiguously designate a geographic location. The address components are, for example, a name of a location or a street name. After the first letters have been input, in each case a selection list with address components which match the letters which have been input is offered to the user and the user can select the respectively desired, unambiguous address component from said list. The address components together form a predefined destination for the navigation process. However, such separate inputting of address components is time-consuming.

### SUMMARY OF THE INVENTION

An object of the invention is to provide a device and a server system for navigating a vehicle in which a destination can easily be predefined.

The object is achieved by a device for navigating a vehicle to a predefinable destination, the predefinable destination being predefinable by a first address representation of a geographic location, the device including at least one interface unit to which the first address representation can be supplied at the input end, at least one address recognition unit which is designed to determine a second address representation from the first address representation, an address conversion unit which is designed to convert the second address representation into a geographic coordinate representation, and a navigation unit which is designed to carry out routing to the predefined destination as a function of the geographic coordinate representation.

The inventors have recognized that users of devices for navigating the vehicle usually have a large number of addresses which represent a potential destination for the navigation process. However, these addresses are available in different forms or modes of representation or at different locations, for example in a mobile telephone, in a personal digital assistant, on a visitor's card, as a notebook entry, as an excerpt from a street plan of a town or as a photo of the geographic location. Such representations of addresses form the first address representation which designate or represent a geographic location which is input to the at least one interface unit.

Navigation is effected by a mathematical reference system formed by a coordinate system. The first address representation is therefore converted into the geographic coordinate representation which unambiguously predefines a position of the geographic location with respect to the coordinate system. The routing to the predefined destination can be carried out by visual or audible signals, by a graphic representation of route information, by a graphic representation of an excerpt from a map, or by other suitable measures known or hereafter developed for providing the driver of the vehicle with instructions or directions which permit the driver to find his way to the predefined destination as a function of said instructions or directions. The routing process may also comprise the determination of a suitable route to the predefined destination such as, for example, from a current position.

According to an embodiment of the present invention, the predefinition of the destination is very easily possible by supplying the first address representation. More specifically, the user can use already existing addresses or address representations to predefine the destination without having to input the respective address or its address components again. The first address representation can be supplied using different media depending on an embodiment of the interface unit.

The geographic location can be represented by the first address representation using different modes of representation such as, for example, a spoken address, a written address or a photo of the geographic location, depending on an embodiment of the at least one address recognition unit. Each address recognition unit is designed to determine the second address representation from a specific mode of representation of the geographic location by the first address representation.

The object of the present invention is also met by a device designed to navigate a vehicle to a predefinable destination, wherein the predefinable destination is predefinable by a first address representation of a geographic location, the device comprising at least one interface unit having an input end to which the first address representation can be supplied, at least one address recognition unit designed to determine a second address representation from the first address representation, a first transceiver unit transmitting the second address representation to a server system and receiving from the server system a geographic coordinate representation of the geographic location or a route to the predefined destination or corresponding directions, and a navigation unit which is designed to carry out routing to the predefined destination as a function of the geographic coordinate representation, the route or the directions.

This embodiment also allows the predefinition of the destination by supplying the first address representation. More specifically, the user uses already existing addresses or address representations to predefine the destination without having to input the respective address or its address components again. The first address representation can be supplied using different media as a function of an embodiment of the interface unit.

The geographic location can be represented by the first address representation using different modes of representation such as, for example, a spoken address, a written address or a photo of the geographic location, depending on an embodiment of the at least one address recognition unit. Each address recognition unit is designed to determine the second address representation from a specific mode of representation of the geographic location by the first address representation.

The device of this embodiment is of simple design since the conversion of the second address representation into the geographic coordinate representation and, if appropriate, the determination of the route or of the directions can be carried out by the server system. Directions may comprise instructions to the driver of the vehicle which permit him to drive the vehicle to the predefined destination. However, directions can also comprise control signals or actuation signals which permit the vehicle to be steered automatically to the predefined destination.

According to a specific embodiment of the device, the first address representation is a spoken address. The at least one address recognition unit is designed to recognize speech. The advantage of this embodiment is that the first address representation can be supplied very easily to the device by speaking the address.

According to another embodiment of the device, the first address representation is an image of a written address. The at least one address recognition unit is in this case designed to recognize script. The advantage of this embodiment is that the image, as a first address representation, is generated very easily by digitization such as, for example, by scanning in a visitor's card or by photography.

According to yet another embodiment, the first address representation is an image of the geographic location. The at least one address recognition unit is designed to recognize the geographic location represented in the image. The advantage of this embodiment is that the image, as a first address representation, is generated very easily by digitization such as, for example, by scanning in a brochure or by photography.

The object of the invention is also met by a device designed to navigate a vehicle to a predefinable destination, wherein the predefinable destination is predefinable by a first address representation of a geographic location, the device comprising at least one interface unit having an input end to which the first address representation can be supplied, a first transceiver unit designed to transmit the first address representation to a server system and to receive a second address representation from the server system, an address conversion unit designed to convert the second address representation into a geographic coordinate representation, and a navigation unit which is designed to carry out routing to the predefined destination as a function of the geographic coordinate representation.

This embodiment also allows the predefinition of the destination by supplying the first address representation. More specifically, the user uses already existing addresses or address representations to predefine the destination without having to input the respective address or its address components again. The first address representation can be supplied using different media as a function of an embodiment of the interface unit.

This device can be of simple design since recognizing an address in the first address representation is performed by the server system.

According to an embodiment of the device, the at least one address recognition unit or the address conversion unit is designed to determine address components of the first or second address representation and to recognize and/or correct errors in the address components. The address components include, for example, a location name, a street name, a name of a subway station, a name of a hotel, or a name of a trade fair. The user in this case does not have to predefine the address components as such or supply them separately. Rather, the address components are determined from the first or second address representation in a context-related fashion. In addition, typical writing mistakes can be corrected automatically as appropriate so that the user does not have to intervene in a corrective fashion. As a result, it is particularly easy to predefine the destination in order to navigate the vehicle.

The at least one address recognition unit or the address conversion unit is designed to check the address components for lack of ambiguity and to provide at least one selection list of similar, respectively unambiguous address components from which a desired address component can be selected by the user if the respective address component is not unambiguous. The advantage is that the user only has to make a selection if an address component is ambiguous, in particular also in conjunction with other address components. As a result, the effort involved in predefining the destination to the device is minimized.

The object of the present invention is also met by a device designed to navigate a vehicle to a predefinable destination, wherein the predefinable destination is predefinable by a first address representation of a geographic location, the device comprising at least one interface unit having an input end to which the first address representation can be supplied. The device comprises a first transceiver unit designed to transmit the first address representation to a server system and to receive from the server system a geographic coordinate representation of the geographic location or a route to the predefined destination or corresponding directions, and a navigation unit designed to carry out routing to the predefined destination as a function of the geographic coordinate representation, the route or the directions.

This embodiment also allows the predefinition of the destination by supplying the first address representation. More specifically, the user uses already existing addresses or address representations to predefine the destination without having to input the respective address or its address components again. The first address representation can be supplied using different media as a function of an embodiment of the interface unit.

The device can be of particularly simple design since the recognition of the address in the first address representation and the conversion into the geographic coordinate representation and, if appropriate, the determination of the route or the directions can be performed by the server system.

According to an embodiment of the device, the first address representation and/or the second address representation are a text. This has the advantage that a text, in particular an alphanumeric text, permits very simple representation and further processing of the address. In particular, address recognition units are known which recognize speech or script and can convert it into a text. An example of a suitable text-based data format for representing addresses is VCARD data format for forming the first or second address representation.

According to a further embodiment, the device comprises at least one internal database or the device can be connected to at least one external database. In this embodiment, the device is designed to determine the second address representation and/or the geographic coordinate representation by interrogating or sending an inquiry to the at least one internal database and/or the at least one external database. This embodiment allows geographic coordinate representation to be determined for a very large number of possible addresses. The databases, in particular the external database, can be easily capable of expansion or updating so that the geographic coordinate representation can, for example, also be determined for new addresses which were not yet available, for example, at the time when the device was manufactured. The internal database can, for example, also be an electronic address book in which the user can store geographic locations which are significant for the user.

The device may further comprise a position determining unit for determining a current position. This allows a current position to be stored as a coordinate representation in the internal database and/or in the external database, together with an address or a designation of the associated geographic location. The user can individually store geographic locations or predefine them as a destination for the navigation even if until now the respective geographic location at the current position has not yet had an address assigned to it which is stored in the internal or the external database. This embodiment allows the internal database, the address book, and/or the external database to be expanded easily.

The object of the invention is also met by a server system which comprises a transceiver unit, at least one address recognition unit and an address conversion unit. The transceiver unit is designed to receive a first address representation from, for example, the device for navigating the vehicle. The at least one address recognition unit is designed to determine a second address representation from the first address representation. The address conversion unit is designed to convert the second address representation into a geographic coordinate representation or to determine a route to the predefined destination or corresponding directions. The server system is designed to transmit the geographic coordinate representation, the route or the directions via the second transceiver unit to, for example, the device for navigating the vehicle.

More resources can very easily be assigned to the server system than to the device for navigating the vehicle. In particular, the server system can be designed as a control center and designed such that the server system can be used independently for a plurality of devices, and if appropriate simultaneously. In addition, the server system can be designed so as to be easily capable of being expanded or updated or can comprise at least one database or can be capable of being connected to at least one database to be able to take into account current information, for example traffic information or route information or current events such as, for example, trade fairs, concerts or sports events.

The object of the present invention is also met by a server system which comprises a transceiver unit and at least one address recognition unit from, for example, the device for navigating a vehicle. The transceiver unit is designed to receive a first address representation. The at least one address recognition unit is designed to determine a second address representation from the first address representation. The server system is designed to transmit the second address representation via the second transceiver unit to, for example, the device for navigating a vehicle.

More resources can very easily be assigned to the server system than to the device for navigating the vehicle. In particular, the server system can be designed as a control center and designed such that the server system can be used independently for a plurality of devices, and if appropriate simultaneously. In addition, the server system is capable of being easily expanded or updated or can comprise at least one database or can be capable of being connected to at least one database.

In one embodiment of the server system, the first address representation is a spoken address, and the at least one address recognition unit is designed to recognize speech. The spoken address is very easily be transmitted to the server system, for example as an audio file or as an audio data stream.

In an alternative or additional embodiment of the server system, the first address representation is an image of a written address, and the at least one address recognition unit is designed to recognize script. This image can very easily be transmitted to the server system, for example as an image file.

In a further alternative or additional embodiment of the server system, the first address representation is an image of a geographic location, and the at least one address recognition unit is designed to recognize the geographic location represented in the image. This image is also easily be transmitted to the server system, for example as an image file.

The at least one address recognition unit or the address conversion unit of the server system is designed to determine address components of the first or second address representation and to recognize and/or correct errors in the address components. Therefore, the user does not need to predefine the address components on a suitable device, or supply them separately, but rather the address components are determined from the first or the second address representation in a context-related fashion. In addition, this embodiment allows typical writing mistakes to be corrected automatically as appropriate so that the user does not need to intervene in a corrective fashion. As a result, the predefinition of the destination on the device to navigate the vehicle is particularly easy.

The at least one address recognition unit or the address conversion unit may be designed to check the address components for lack of ambiguity and to provide at least one selection list of similar, respectively unambiguous address components from which a desired address component can be selected by a user if the respective address component is not unambiguous. The user only has to make a selection on the suitable device if an address component is ambiguous, in particular also in relation to further address components. The at least one selection list can easily be made available to the user on the device via the second transceiver unit. As a result, the effort involved in predefining the destination to the device is minimized.

In a further advantageous embodiment of the server system, the first address representation and/or the second address representation are a text. This has the advantage that a text, in particular an alphanumeric text, permits very easy representation and further processing of the address. In particular, address recognition units are known which recognize speech or script and can convert it into a text. The text-based data format may, for example, comprise the VCARD format, which is a known text-based data format suitable for representing addresses and forming the first or second address representation.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference numbers denote similar elements throughout the several views:

FIG. 1 is a schematic block diagram showing components of a device for navigating a vehicle;

FIG. 2 is a schematic block diagram showing components of a further device for navigating a vehicle,

FIG. 3 is a schematic block diagram showing components of a server system according to an embodiment of the present invention,

FIG. 4 is a flowchart showing the steps of a method according to an embodiment of the present invention;

FIG. 5 is a flowchart showing the steps of a method according to a second embodiment of the present inventions; and

FIG. 6 is a flowchart showing the steps of a method according to a third embodiment of the present inventions.

### DETAILED DESCRIPTION OF THE PRESENTLY PREFERRED EMBODIMENTS

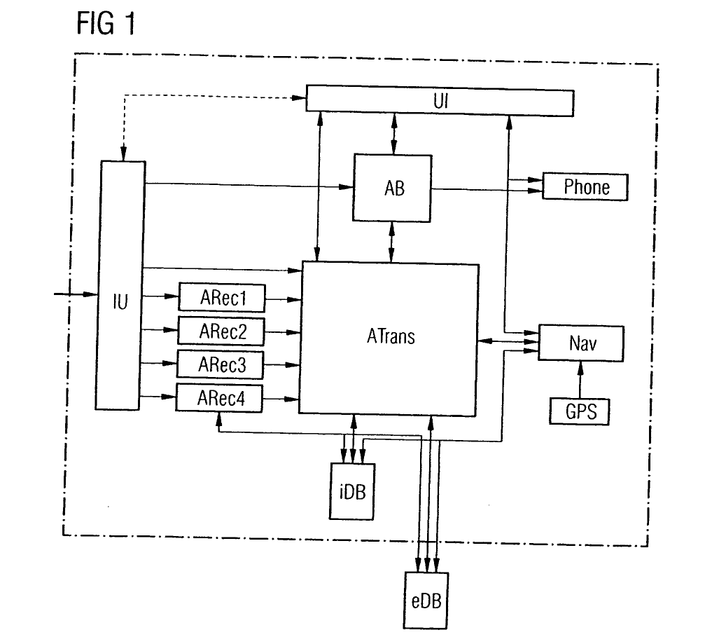

FIG. 1 shows a device for navigating a vehicle which comprises an interface unit IU, an address conversion unit ATrans, and a navigation unit Nav. The device for navigating a vehicle (hereafter ‘the device’) is preferably arranged in the vehicle. The address conversion unit ATrans has an input end connected to the interface unit IU and an output end connected to the navigation unit Nav.

The device comprises a first address recognition unit ARec1, a second address recognition unit ARec2, a third address recognition unit ARec3 and a fourth address recognition unit ARec4. Although four address recognition units are shown, fewer or more address recognition units may alternatively be provided. The first address recognition unit ARec1, the second address recognition unit ARec2, the third address recognition unit ARec3 and the fourth address recognition unit ARec4 each have an input end connected to the interface unit IU and an output end connected to the address recognition unit ATrans.

The device also includes an electronic address book AB and a user interface UI. The address book AB is connected to the interface unit IU, the address conversion unit ATrans, and the user interface UI. The device may also comprise a telephone unit Phone which is connected to the address book AB and to the user interface UI.

The navigation unit Nav is also connected to a position determining unit GPS such as, for example, a Global Positioning System receiver which is designed to determine a current position of the vehicle. An internal database iDB is connected to the address conversion unit ATrans and the navigation unit Nav. The internal database iDB may also be connected to the fourth address recognition unit ARec4. In the embodiments that do not include the fourth address recognition unit ARec4, the internal database iDB may not be connected to any address recognition units. The device may optionally includes an external database eDB which can be connected to the address conversion unit ATrans, the navigation unit Nav and/or the fourth address recognition unit ARec4. It is also possible to provide a plurality of internal databases iDB and/or external databases eDB. In particular, the address book AB may be designed as an internal database iDB or as an external database eDB.

A first address representation can be supplied to the interface unit IU by the user. The first address representation designates or represents a geographic location which is provided, for example, as a town, as a road and/or as a building. The first address representation is preferably a compact digital representation of the geographic location or of an address which is assigned to the geographic location. The digital representation may, for example, be in the form of a file or a data stream. The term “compact” means in this context that, for example, the address is represented in a coherent fashion in the first address representation and can thus be supplied in a coherent form, i.e., as a single unit, to the interface unit IU. In contrast to this, known devices for navigating a vehicle require the various address components, such as for example a street name or a name of a locality, to be supplied separately, said components having to be input into the device manually or selected by a user.

The first address representation can be supplied to the interface unit IU as, for example, an image or a text. The first address representation may be supplied to the interface unit IU using wireless data transmission (i.e., Bluetooth, infrared, or a wireless local area network) or using wire-bound data transmission (i.e., a universal serial bus, for example from a mobile telephone or from a personal digital assistant (PDA), or using memory media such as, for example, compact discs, digital versatile discs or flash memory media). In addition, the interface unit IU can, for example, also be connected to a microphone and an analog/digital converter. The first address representation may then comprise, for example, a spoken address which can be spoken into the microphone by the user.

The address conversion unit ATrans is designed to determine a geographic coordinate representation of the geographic location from the first address representation provided that the first address representation is in a suitable form. The geographic coordinate representation is suitable as a predefined destination for the navigation unit Nav. The navigation unit Nav is designed to determine a suitable route from the current position to the destination as a function of the current position of the vehicle and the predefined destination, and to supply the user of the device, via the user interface UI, with directions which permit the user to steer the vehicle to the destination. The geographic coordinate representation can be based on a geographic or ecliptic coordinate system or on some other coordinate system. The geographic coordinate representation may, for example, be formed, by a WGS84 coordinate.

However, the navigation unit Nav may alternatively be designed to permit the route to be determined by a server system and to permit corresponding directions to be supplied to the user or to permit the directions to be determined by the server system and suitably conveyed to the user via the user interface UI. In this case, the device preferably comprises a transceiver unit for communicating with the server system. The device can likewise be connected to the external database eDB via the transceiver unit. In a specific embodiment, the transceiver unit may be formed, for example, by the telephone unit Phone.

In one embodiment, the first address representation is a text, in particular an alphanumeric text, with a predefined structure which corresponds, for example, to a virtual visitor's card. Such a text-based virtual visitor's card is known as a VCARD. Instead of a structure corresponding to a virtual visitor's card, the first address representation be arranged in any other predefined structures that are known or hereafter developed. By means of the predefined structure, the address conversion unit ATrans can determine address components from the first address representation. Address components are, for example, a name of a locality, a street name, or a name of a company. The first address representation can, however, also comprise other address components such as a name of a subway station, a name of a hotel, a name of a restaurant, a name of a trade fair or a name of a person to whom, for example, a residential address or a place of work can be assigned. After determining the address components, the address conversion unit ATrans then determines the associated geographic coordinate representation from the address components. The internal database iDB and/or the external database eDB and also the address book AB can be used for determining the geographic coordinate representation.

If the first address representation is a spoken address, the spoken address is preferably supplied to the first address recognition unit ARec1 which is designed to recognize speech, convert it into a text, and to recognize address components. If the first address representation is an image, for example of a digitized visitor's card, the image is supplied to the second address recognition unit ARec2 which is designed to recognize script and preferably convert it into a text and to recognize address components. The first address representation may alternatively comprise a handwritten address supplied in digitized form to the third address recognition unit ARec3 which is designed to recognize the handwriting and convert it into a text and to recognize address components. The second address recognition unit ARec2 and the third address recognition unit ARec3 are preferably designed to recognize address fields, for example of letters or visitor's cards.

In addition, the first address representation may also be a photograph of the geographic location such as, for example, of a building or of a square or block. The photograph is preferably supplied to the fourth address recognition unit ARec4. The fourth address recognition unit ARec4 is designed to recognize the geographic location which is represented on the photograph and to determine the address which is assigned to said geographic location. For this purpose, the fourth address recognition unit ARec4 may send an inquiry to the internal database iDB and/or to the external database eDB, as necessary. It is however also possible, for example, to determine a residential address of a person who is on the photograph or to determine another geographic location which is associated with this person.

The first address recognition unit ARec1, the second address recognition unit ARec2, the third address recognition unit ARec3 and the fourth address recognition unit ARec4 are designed to convert the first address representation into a second address representation which is preferably an alphanumeric text. The second address representation is supplied to the address conversion unit ATrans. The address conversion unit ATrans also determines the associated geographic coordinate representation from the second address representation in accordance with the first address representation.

The fourth address recognition unit ARec4 can also be designed to download and execute a suitable address recognition algorithm from the internal database iDB and/or the external database eDB, as a function of a data format of the first address representation. According to this embodiment, a large number of data formats are supported. Furthermore, only a small number of address recognition units or, alternatively, only the fourth address recognition unit ARec4 is then need to be provided in the device. Using this downloading function, the device can thus be expanded very easily to support other address recognition algorithms or data formats.

FIG. 2 shows a further device for navigating a vehicle which comprises a first transceiver unit TR1 having an input end connected to an interface unit IU and having an output end connected to a navigation unit Nav. Instead of being a separate transceiver, the first transceiver unit TR1 may also comprise the telephone unit Phone. That is, the telephone unit Phone may be designed as the first transceiver unit TR1 or comprise the first transceiver unit. The device in FIG. 2 also includes an address book AB and user interface UI as the device shown in FIG. 1.

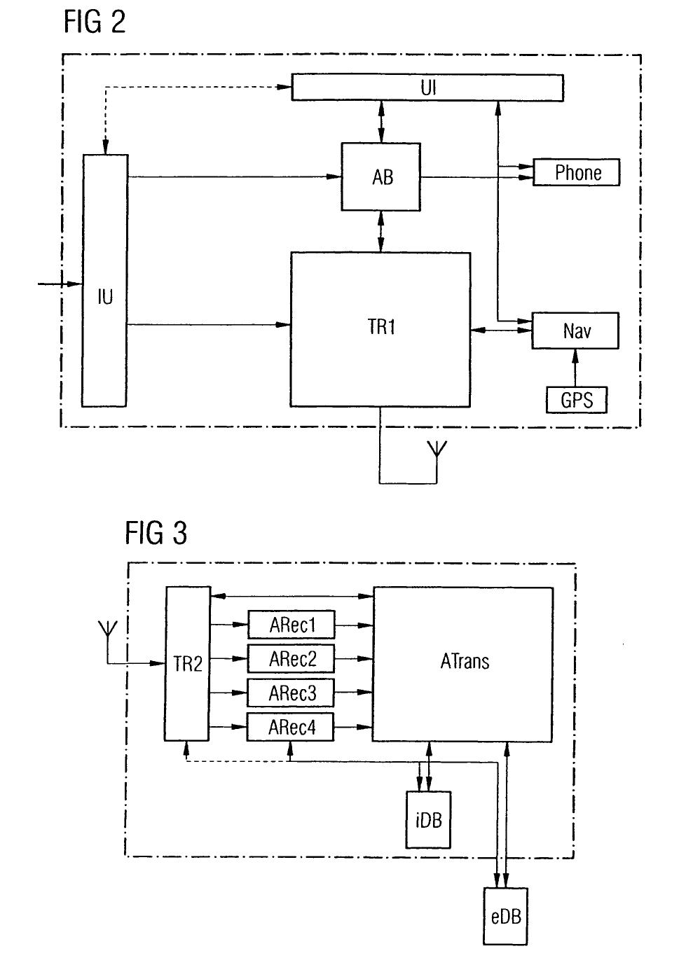

FIG. 3 shows a server system remote from the device of FIG. 2 which includes a first address recognition unit ARec1, a second address recognition unit ARec2, a third address recognition unit ARec3 and a fourth address recognition unit ARec4 as well as an address conversion unit ATrans. The server system of FIG. 3 also includes at least one internal database iDB. In addition, the server system is capable of being connected to at least one external database eDB.

The server system of FIG. 3 has a second transceiver unit TR2. The server system is preferably designed such that more than one of the devices for navigating a vehicle communicates with the server system, independently and/or simultaneously. The server system may also comprise more than one transceiver unit TR2 which may be distributed among various locations. The first transceiver unit TR1 and the second transceiver unit TR2 are capable of being connected to one another via a radio link. The server system can also, for example, be connected to the Internet or to another network such as, for example, a telephone network or a mobile radio network.

The device is preferably designed in such a way that the first address representation is transmitted to the second transceiver unit TR2 via the first transceiver unit TR1. The server system determines, from the first address representation, the geographic coordinate representation, the route to the predefined destination, and/or corresponding directions to steer the vehicle to the predefined destination. The geographic coordinate representation, the route or the directions can then be transmitted to the first transceiver unit TR1 by the second transceiver unit TR2, and then supplied to the navigation unit Nav in the device.

Although FIGS. 2 and 3 show that each of the address recognition units ARec1-ARec4 is arranged in the server system, it is possible to arrange only one or more of the address recognition units ARec1-ARec4 into the server system. In another alternative embodiment, only the address conversion unit ATrans is arranged at the server system. In yet another alternative embodiment, only the at least one internal database iDB and/or the at least one external database eDB is arranged at the server system. Likewise, it is also possible to export only the determination of the route or of the directions out of the device. The server system can also be designed as the external database eDB for the device.

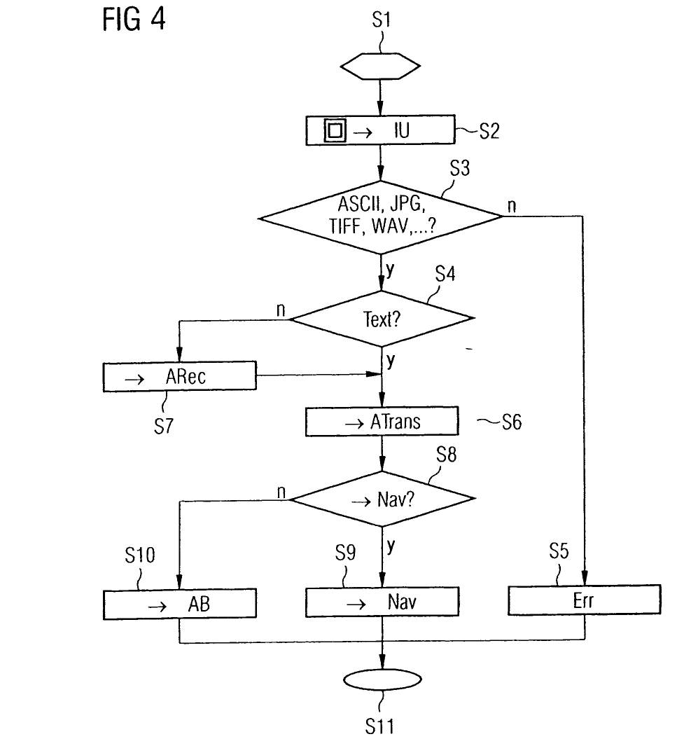

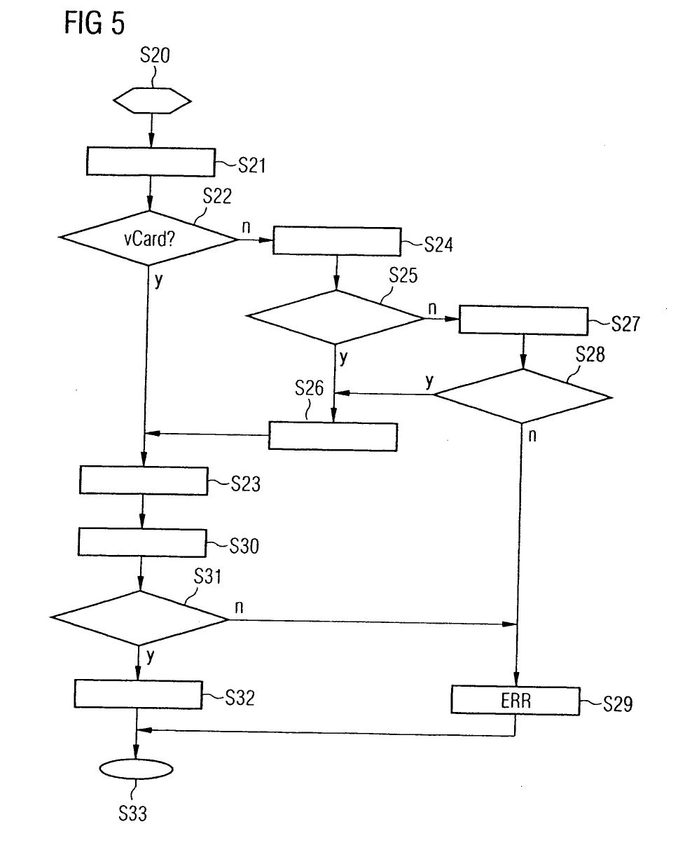

FIG. 4 shows a flowchart of a method which is executed by the device. The method starts in a step S1. In a step S2, the first address representation is supplied to the device, in particular to the interface unit IU. In a step S3, the interface unit checks whether the first address representation is present in an acceptable data format, that is to say in a data format which can be processed by the address conversion unit ATrans or one of the address recognition units. If this condition is satisfied, the method is continued in a step S4. However, if the condition of step S3 is not satisfied, a fault message is output by the user interface UI in a step S5 and the method is ended in a step S11.

In the step S4 it is checked whether the first address representation is an alphanumeric text. If the condition is satisfied, in a step S6 the first address representation is converted into the associated geographic coordinate representation in the address conversion unit ATrans. However, if the first address representation is not an alphanumeric text in the step S4, the first address representation is supplied to at least one of the address recognition units in a step S7. The recognized address which is converted into the alphanumeric text in step S7 is then supplied as a second address representation to the address conversion unit ATrans in the step S6.

In a step S8 it is checked whether the geographic coordinate representation is to be used as a predefined destination in the navigation unit Nav. If this condition is satisfied, the geographic coordinate representation is supplied to the navigation unit Nav in a step S9. However, otherwise the geographic coordinate representation can also be stored in the address book AB in a step S10 so that it can be looked up in the future. The method ends in the step S11 after steps S9 or S10.

FIG. 5 shows a second flowchart of a method for determining and processing address components of the first or second address representation which is performed as part of step S6 in FIG. 4. The method of the second flowchart starts in a step S20. The alphanumeric text, which is provided by either the first address representation or by the second address representation, is read in step S21.

In a step S22 it is checked whether the address is present in a structured text format, for example as a VCARD. If this condition is satisfied, the method is continued in a step S23. However, if the condition of step S22 is not satisfied, a search for typical designators of address components is performed, step S24. Such typical designators are, for example, street, location, zip code or ZC. In a step S25 it is checked whether such designators have been found. If the condition of step S25 is satisfied, step S26 is performed in which the address components are recognized by reference to the designators. The method can then be continued in the step S23. However, if no designators were found in the step S25, typical names of localities or street names or sequences of numbers, for example of zip codes or house numbers, are searched for in a step S27. In particular, it is possible, for example, also to search for typical endings of names of localities or for abbreviations to determine the address components. Typical abbreviations are, for example, include “St” and “Str” for “street” and “Sq” for “square”.

In a step S28 it is then checked whether it was possible to determine typical names of localities or street names, sequences of numbers or abbreviations. If this condition is satisfied, the address components can be determined in the step S26. However, if the condition is not satisfied, a fault message is generated in a step S29 and the method is ended in a step S33.

After the address components have been determined in step S22 or S26, the address components are checked for errors, for example for typical typing errors or writing mistakes or for recognition errors, in the step S23. Recognized errors are then automatically corrected as appropriate. In a step S30, typical abbreviations are resolved, for example “Str” is replaced by “street”. In a step S31 it is then checked whether all the address components which are necessary to determine the geographic coordinate representation are provided. For example, a street name alone is usually not sufficient to be able to determine the geographic coordinate representation. However, the street name in combination with the name of the locality or the street name in combination with the zip code can form a convertible address. If a convertible address is available, this is made available in a step S32 for the conversion of the address into the geographic coordinate representation, and the method is ended in the step S33. However, if a convertible address is not available, the fault message is generated in the step S29 and the method is ended in the step S33.

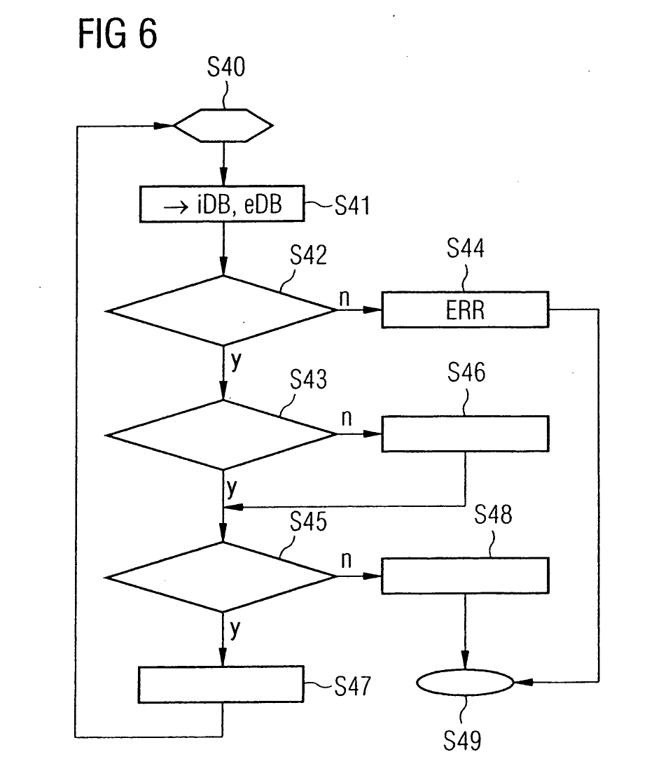

FIG. 6 shows a flowchart of a method for converting the address into the geographic coordinate representation of the geographic location. The method starts in a step S40 which preferably follows or is performed as part of the step S32. In a step S41, an address component, for example the name of the locality, is compared with the internal database iDB and/or the external database eDB. In a step S42 it is checked whether the address component has been found. If this condition is satisfied, the method is continued in a step S43. However, if the condition is not satisfied, the fault message is generated in a step S44 and the method is ended in a step S49.

In the step S43 it is checked whether the respective address component is unambiguous. For example, there may be a plurality of locations which have the same name. An example of a locality name which refers to two locations is Frankfurt. In Germany, the locality Frankfurt may refer to either Frankfurt an der Oder or Frankfurt am Main. Similarly, the locality Wetter may refer to either Wetter an der Ruhr or Wetter in the district of Marburg. The respective address component may also be ambiguous as a result of a writing mistake which could not be corrected automatically. If the address component is unambiguous, the method is continued in a step S45. However, if the address component is ambiguous, a selection list, from which the desired unambiguous address component can be selected, is made available to the user in a step S46. In the example of Frankfurt, the user could choose between Frankfurt on Main or Frankfurt an der Oder. Only the unambiguous address components which have a high degree of correspondence to the ambiguous address component are preferably listed in the selection list. The method is then also continued in the step S45. However, if appropriate, the lack of ambiguity of address components may be established by the fact that a plurality of address components, for example the name of a locality and the zip code or the street name and the name of a locality, are linked to one another. For example, the ambiguity of a locality may be obviated if the street name of the locality exists, for example, only for one of the possible locations.

In step S45 it is checked whether further address components are present or necessary to determine the geographic coordinate representation, for example the number of the building, which may be useful in particular for long streets. If this condition is satisfied, a further address component is selected in a step S47 and compared again with the database in the step S41. Otherwise, in a step S48 the geographic coordinate representation is determined and the method is ended in the step S49.

The geographic coordinate representation which is determined in step S48 may be stored with the first or the second address representation or with the corrected and unambiguous address components in the internal database iDB, in particular in the address book AB, or else in the external database eDB, so that the first address representation has to be converted into the coordinate representation only once, and the geographic coordinate representation is available for later use. It is also possible to supply the corrected and unambiguous address components to, for example, the mobile telephone or the personal digital assistant to replace faulty address components there.

The first address representation may also represent in particular locations of particular interest, i.e., points of interest. For example, the unambiguous geographic coordinate representation can be determined from an entry in an appointment calendar, for example “book fair Frankfurt” or “Frankfurt book fair”, by database interrogation without having to specify complete details about the location, street, zip code and number of the building. This simplification may also be used, for example, to predefine a hotel, a restaurant, a subway station or company premises as a navigation destination. In particular, it is possible, for example, to predefine the closest hotel or restaurant as a navigation destination as a function of the current position of the vehicle. The user then only has to intervene if details are incomplete and cannot be resolved or are ambiguous. By linking one or more databases which can be interrogated such as, for example, an external database eDB, it is also possible to determine geographic coordinate representations for which there is no information in the internal database iDB or for which existing information in the internal database iDB is out of date. These databases may be interrogated via a radio link such as, for example, by mobile radio, and/or over the Internet. For example, search machines may be interrogated via the Internet to search for trade fairs, hotels, restaurants or other points of interest or for other geographic locations and they can respectively determine the geographic coordinate representation for the searched geographic location.

The internal database iDB and/or the external database eDB can be of expandable design, i.e. may be written to. For example, a current position determined by the position determining unit GPS can be provided with address components on request and be stored in the internal database iDB, the external database eDB, or the address book AB.

The processes of recognizing address fields and address components, replacing abbreviations and, if appropriate, correcting writing mistakes and forming combinations of address components which together form the convertible address are preferably designed to be country-specific and language-specific since the address format or the way of spelling names of localities, for example, may vary.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device for navigating a vehicle to a destination, the destination being predefinable by a first address representation of a geographic location of the destination, said device comprising:
an interface unit having an input end for receiving the first address representation;
an address recognition unit determining a second address representation from the first address representation;
an address conversion unit converting the second address representation into a geographic coordinate representation; and
a navigation unit effecting routing to the predefined destination as a function of the geographic coordinate representation.

2. The device of claim 1, wherein said navigation unit is configured and dimensioned for effecting routing by at least one of determining a route to the predefined destination and supplying driving directions the predefined destination.

3. The device of claim 1, wherein the first address representation is a spoken address, said address recognition unit being configured to recognize speech and convert the spoken address into the second address representation in the form of text.

4. The device of claim 1, wherein the first address representation is an image of a written address, said address recognition unit being configured to recognize script and convert the image into the second address representation in the form of text.

5. The device of claim 1, wherein the first address representation is an image of a geographic location, said address recognition unit being configured to recognize the geographic location represented in the image and convert the image into the second address representation in the form of text.

6. The device of claim 1, wherein at least one of said address recognition unit and said address conversion unit is configured and dimensioned for determining address components of the first address representation or the second address representation and at least one of recognizing and correcting errors in the determined address components.

7. The device of claim 6, wherein at least one of the address recognition unit and the address conversion unit is configured to check the address components for lack of ambiguity and to provide at least one selection list of similar, respectively unambiguous address components from which a desired address component can be selected by a user if the respective address component is not unambiguous.

8. The device of claim 1, wherein at least one of the first address representation and the second address representation is a text having a predetermined structure.

9. The device of claim 1, comprising an internal database or being connectable to an external database, said device being arranged and dimensioned for interrogating the internal database or the external database to determine at least one of the second address representation and the geographic coordinate representation.

10. The device of claim 9, further comprising a position determining unit determining a current position of said device, the current position being storable in the internal database or the external database as a geographic coordinate representation together with an address or a designation of a geographic location associated with the current position.

11. The device of claim 1, wherein said address recognition unit comprises a plurality of address recognition units, each recognizing a different mode of address representation.

12. A device for navigating a vehicle to a destination, the destination being predefinable by a first address representation of a geographic location of the destination, said device comprising:
an interface unit having an input end for receiving the first address representation;
an address recognition unit determining a second address representation from the first address representation;
a first transceiver unit arranged and dimensioned for transmitting the second address representation to a server system and receiving therefrom a geographic coordinate representation of the geographic location, a route to the predefined destination, or directions to the predefined destination; and
a navigation unit effecting routing to the predefined destination as a function of the geographic coordinate representation, the route or the directions.

13. The device of claim 12, wherein the first address representation is a spoken address, said address recognition unit being configured to recognize speech and convert the spoken address into the second address representation in the form of text.

14. The device of claim 12, wherein the first address representation is an image of a written address, said address recognition unit being configured to recognize script and convert the image into the second address representation in the form of text.

15. The device of claim 12, wherein the first address representation is an image of a geographic location, said address recognition unit being configured to recognize the geographic location represented in the image and convert the image into the second address representation in the form of text.

16. The device of claim 12, wherein said address recognition unit is configured and dimensioned for determining address components of the first address representation or the second address representation and at least one of recognizing and correcting errors in the determined address components.

17. The device of claim 16, wherein the address recognition unit is configured to check the address components for lack of ambiguity and to provide at least one selection list of similar, respectively unambiguous address components from which a desired address component can be selected by a user if the respective address component is not unambiguous.

18. The device of claim 12, wherein at least one of the first address representation and the second address representation is a text having a predetermined structure.

19. The device of claim 12, comprising an internal database or being connectable to an external database, said device being arranged and dimensioned for interrogating the internal database or the external database to determine the second address representation.

20. The device of claim 19, further comprising a position determining unit determining a current position of said device, the current position being storable in the internal database or the external database as a geographic coordinate representation together with an address or a designation of a geographic location associated with the current position.

21. A device for navigating a vehicle to a destination, the destination being predefinable by a first address representation of a geographic location, said device comprising:
an interface unit having an input end for receiving the first address representation;
a first transceiver unit arranged and dimensioned for transmitting the first address representation to a server system and receiving a second address representation from the server system;
an address conversion unit converting the second address representation into a geographic coordinate representation; and
a navigation unit effecting routing to the predefined destination as a function of the geographic coordinate representation.

22. The device of claim 21, wherein said address recognition unit is configured and dimensioned for determining address components of the first address representation or the second address representation and at least one of recognizing and correcting errors in the determined address components.

23. The device of claim 22, wherein said address recognition unit is configured to check the address components for lack of ambiguity and to provide at least one selection list of similar, respectively unambiguous address components from which a desired address component can be selected by a user if the respective address component is not unambiguous.

24. The device of claim 21, wherein at least one of the first address representation and the second address representation is a text having a predetermined structure.

25. The device of claim 21, comprising an internal database or being connectable to an external database, said device being arranged and dimensioned for interrogating the internal database or the external database to determine at least one of the second address representation and the geographic coordinate representation.

26. The device of claim 25, further comprising a position determining unit determining a current position of said device, the current position being storable in the internal database or the external database as a geographic coordinate representation together with an address or a designation of a geographic location associated with the current position.

27. A device for navigating a vehicle to a destination, the destination being predefinable by a first address representation of a geographic location, said device comprising:
an interface unit having an input end for receiving the first address representation;
a first transceiver unit arranged and dimensioned for transmitting the first address representation to a server system and receiving from the server system a geographic coordinate representation of the geographic location, a route to the predefined destination or directions to the predefined destination; and
a navigation unit effecting routing to the predefined destination as a function of the geographic coordinate representation, the route or the directions.

28. The device of claim 27, wherein at least one of the first address representation and the second address representation is a text having a predetermined structure.

29. The device of claim 27, comprising an internal database or being connectable to an external database, said device being arranged and dimensioned for interrogating the internal database or the external database to determine at least one of the second address representation and the geographic coordinate representation.

30. The device of claim 27, further comprising a position determining unit determining a current position of said device, the current position being storable in the internal database or the external database as a geographic coordinate representation together with an address or a designation of a geographic location associated with the current position.

31. A server system, comprising:
a transceiver unit arranged and dimensioned to receive a first address representation;
an address recognition unit determining a second address representation from the first address representation;
an address conversion unit converting the second address representation into a geographic coordinate representation, a route to the predefined destination, or directions to the predefined destination, said transceiver further arranged for transmitting the geographic coordinate representation, the route or the directions.

32. The server system of claim 31, wherein the first address representation is a spoken address, said address recognition unit arranged and dimensioned for recognizing speech and converting the spoken address to the second address representation in the form of text.

33. The server system of claim 31, wherein the first address representation is an image of a written address, said address recognition unit being arranged and dimensioned for recognizing script and converting the image to the second address representation in the form of text.

34. The server system of claim 31, wherein the first address representation is an image of a geographic location, said address recognition unit being arranged and dimensioned for recognizing the geographic location represented in the image and converting the image to the second address representation in the form of text.

35. The server system of claim 31, wherein one of said address recognition unit and said address conversion unit is arranged and dimensioned for determining address components of the first address representation or the second address representation and for recognizing or correcting errors in the determined address components.

36. The server system of claim 35, wherein said one of said address recognition unit and said address conversion unit is further arranged and dimensioned for checking the address components for lack of ambiguity and providing at least one selection list of similar, respectively unambiguous address components from which a desired address component can be selected by a user if the respective address component is not unambiguous.

37. The server system of claim 31, wherein at least one of the first address representation and the second address representation are a text having a predetermined structure.

38. A server system, comprising:
a transceiver unit arranged and dimensioned for receiving a first address representation;
an address recognition unit determining a second address representation from the first address representation, said transceiver transmitting the second address representation.
